(19) United States
(12) Patent Application Publication
(10) Pub. No.: US 2006/0109306 A1
(43) Pub. Date: May 25, 2006

(54) Inkjet printer

(75) Inventor: Youn-gun Jung, Gunpo-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/172,797

(22) Filed: Jul. 5, 2005

(30) Foreign Application Priority Data
Nov. 24, 2004 (KR) 10-2004-0097014

(51) Int. Cl. B41J 2/165; B41J 2/155

(52) U.S. Cl. 347/42; 347/36

(57) ABSTRACT

An inkjet printer is provided. The inkjet printer includes a print head having a nozzle unit as wide as a sheet of paper, and a waste ink storing apparatus extending across the width of the print head and having a multi-absorption structure to absorb and store waste ink remained around when an image is formed.

### CROSS-REFERENCE TO RELATED APPLICATIONS

This application claims the benefit under 35 U.S.C. §119(a) of Korean Patent Application No. 10-2004-0097014, filed on Nov. 24, 2004, in the Korean Intellectual Property Office, the entire disclosure of which is incorporated herein by reference.

### BACKGROUND OF THE INVENSTION

1. Field of the Invention

The present invention relates to an inkjet printer. More particularly, the invention relates to an inkjet printer including a waste ink storing apparatus for absorbing and storing waste ink remaining around nozzles when an image is formed.

2. Description of the Related Art

Generally, inkjet printers form images by ejecting droplets of ink through a print head suspended above a sheet of paper, shuttling perpendicular to the paper's transport direction.

The print head includes a nozzle unit having a plurality of nozzles that eject ink. After printing, some excess ink remains around the nozzles. Droplets of the ink can accumulate inside the nozzles due to repeated ejections of ink, and drop into undesired places. In addition, when the droplets of ink dry, they absorb particles from the air and become solid deposits. Thus, the particles clog the nozzles, distorting the direction in which ink is ejected. Consequently, print quality deteriorates and the image can not be formed correctly.

To solve this problem, an apparatus for wiping droplets of ink that remain around nozzles is disclosed in Japanese Patent Laid-open Publication Nos. hei 2-113949, 5-092576, 11-254692, and 15-063021.

The apparatus includes wipers slightly wider than the nozzle unit, which is usually less than one inch wide in the direction of the width of a sheet of paper. In order to wipe the nozzle unit, the apparatus shuttles the wipers in the paper movement direction or moves the wipers once or twice in the same direction. In this process, the wipers rub the nozzle unit to wipe away droplets of ink, solid deposits, dust, and the like. This operation is called a wiping operation.

To prevent waste ink from hardening inside the nozzles and clogging them, a small amount of ink is ejected through the nozzles, which is called a spitting operation. When the wiping and spitting operations have been completed, the waste ink is stored in a waste ink storing apparatus installed under the print head.

Recently, there have been attempts to replace a conventional print head which shuttles across the width of a sheet of paper with a print head (hereinafter, Line Array Print Head) including a nozzle unit as wide as a sheet of paper, to facilitate high-speed printing.

Because a Line Array Print Head is wider than the conventional print head, it produces more waste ink than a conventional print head. Therefore, a new waste ink storing apparatus is required to store waste ink removed from the Line Array Print Head.

Accordingly, a need exists for an improved inkjet printer capable of effectively removing and storing waste ink remaining after an image is formed.

### SUMMARY OF THE INVENTION

The present invention provides an inkjet printer including a waste ink storing apparatus for storing waste ink removed from a print head that includes a nozzle unit as wide as a sheet of paper.

According to an exemplary embodiment of the present invention, an inkjet printer including a print head having a nozzle unit as wide as a sheet of paper is provided. A waste ink storing apparatus extends across the width of the print head and has a multi-absorption structure which absorbs and stores waste ink remaining when an image is formed.

### BRIEF DESCRIPTION OF THE DRAWINGS

The above and other features and advantages of the present invention will become more apparent by describing in detail exemplary embodiments of present invention thereof with reference to the attached drawings in which:

FIG. 1 is a perspective view of an inkjet printer including a waste ink storing apparatus according to an embodiment of the present invention;

FIG. 2 is a cross-sectional view of a waste ink storing apparatus according to another embodiment of the present invention;

FIG. 3 is a cross-sectional view of a waste ink storing apparatus according to another embodiment of the present invention;

FIG. 4 is a cross-sectional view illustrating the operation of storing waste ink in the waste ink storing apparatus according to another embodiment of the present invention; and

FIG. 5 is a cross-sectional view illustrating the operation of storing waste ink in the waste ink storing apparatus according to another embodiment of the present invention.

Throughout the drawings, it should be noted that like reference numbers are used to depict the same or similar elements, features and structures.

### DETAILED DESCRIPTION OF EXAMPLARY EMBODIMENTS

Embodiments of the present invention will now be described in detail with reference to the accompanying drawings. Embodiments of the invention may, however, be configured in many different forms and should not be construed as being limited to the exemplary embodiments described therein; rather, these embodiments are provided so that this disclosure will be thorough and complete, and will fully convey the concept of the invention to those skilled in the art.

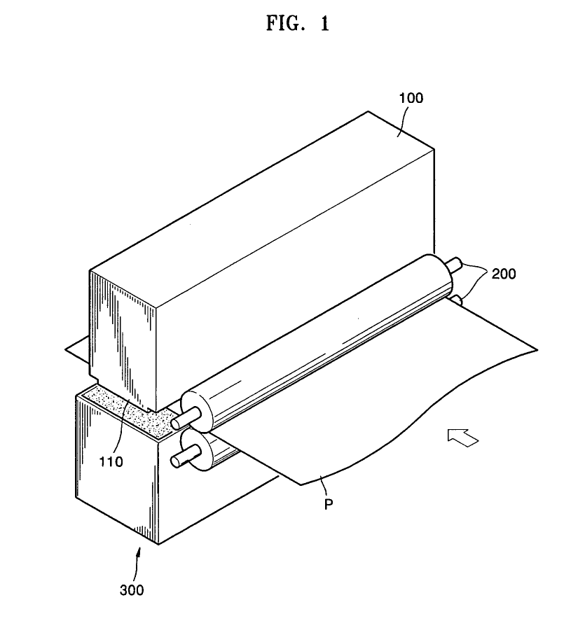

Referring to FIG. 1, an inkjet printer according to an embodiment of present invention includes a print head 100, a nozzle unit 110, a pair of conveying rollers 200, and a waste ink storing apparatus 300. The nozzle unit 110 is included in the print head 100, and is as wide as a sheet of paper P. The conveying rollers 200 face each other and rotate to convey the sheet of paper P through the nozzle unit 110. The waste ink storing apparatus 300 is located under the print head 100 and absorbs and stores the waste ink removed from the nozzle unit 110.

Referring to FIG. 2, a waste ink storing apparatus 300 according to another embodiment of the present invention extends across the width of the print head 100 of FIG. 1. The waste ink storing apparatus 300 includes an absorbing unit 320 and a storing unit 330. The absorbing unit 320 is supported by supporting members 311 located on the upper part of an empty container 310, and it absorbs waste ink removed from the nozzle unit 110. The storing unit 330 is located in the lower part of the empty container and it absorbs and stores the waste ink removed from the nozzle unit 110.

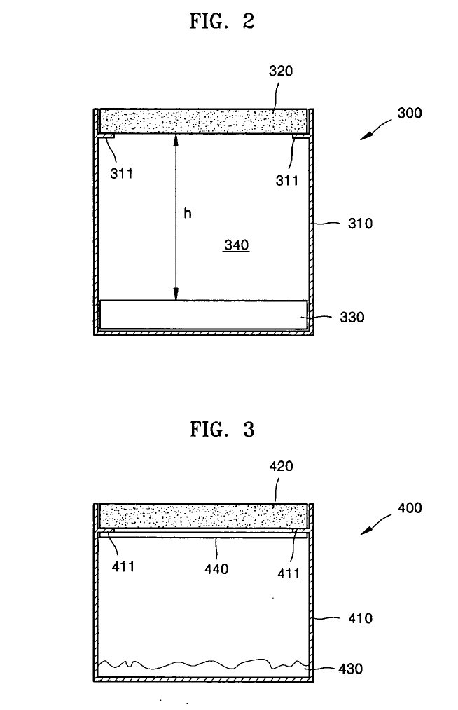

The storing unit 330 may be composed of a polymer. When it absorbs waste ink, the polymer increases in volume and thus can contain the waste ink. Therefore, the storing unit 330 is installed in a predetermined space of a space unit 340 within the container 310. Since the polymer can absorb tens or hundreds of times its own mass in moisture, a sufficient space should be available to accommodate the increased volume when it absorbs the waste ink. To this end, the waste ink storing apparatus 300 has a height h. The storing unit 330 may be composed of any substance such as absorbent polymers which are particularly suited to this function. Referring to FIG. 3, a waste ink storing apparatus 400 according to another embodiment of the present invention extends across the width of the print head 100 of FIG. 1. The waste ink storing apparatus 400 includes an absorbing unit 420 and a storing unit 430. The absorbing unit 420 is supported by supporting members 411 located on the upper part of an empty container 410, and absorbs waste ink removed from a nozzle unit such as the nozzle unit 110 of FIG. 1. The storing unit 430 is located under the absorbing unit 420, and absorbs and stores the waste ink removed from the nozzle unit 110. The waste ink storing apparatus 400 also includes a filtering unit 440 interposed between the absorbing unit 420 and the storing unit 430. The filtering unit 440 allows waste ink to flow from the absorbing unit 420 to the storing unit 430 but it prevents the reverse flow.

The storing unit 430 may be CaCl2. CaCl2 absorbs and stores waste ink in a liquid state. Hence, unlike the waste ink storing apparatus 300 of FIG. 2, the volume of the waste ink storing apparatus 400 does not increase much in volume. Therefore, extra space is not needed in container 410.

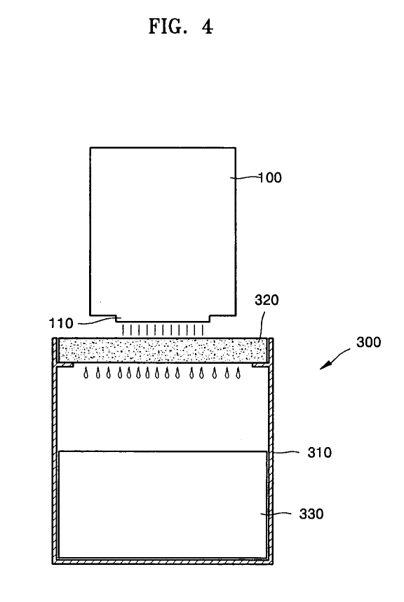

The operation of storing waste ink in the waste ink storing apparatus 300 or 400 according to another exemplary embodiment of the present invention will now be described. Referring to FIG. 4, when an image is formed, waste ink removed by wiping or ejected from the nozzle unit 110 of FIG. 1 by spitting is absorbed by the absorbing unit 320 and eventually drops from the absorbing unit 320 due to its weight and gravity.

The dropped waste ink is absorbed by the storing unit 330. Since the storing unit 330 is composed of a polymer, its volume increases as much as it absorbs the ink. The storing unit 330 stores the waste ink in a gel state.

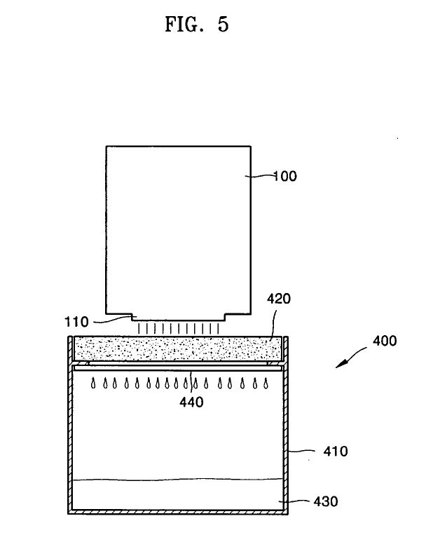

Referring to FIG. 5, when an image is formed, waste ink removed by wiping or ejected from the nozzle unit 110 of FIG. 1 by spitting is absorbed by the absorbing unit 420 and then drops from the absorbing unit 420 due to its weight and gravity.

The dropped waste ink is absorbed by the storing unit 430 through the filtering unit 440. Since the storing unit 430 is composed of CaCl2, it stores the waste ink in a liquid state.

As described above, an inkjet printer according to exemplary embodiments of the present invention includes a waste ink storing apparatus having a multi-absorption structure in which waste ink ejected from a nozzle unit as wide as a sheet of paper is absorbed and stored. By storing waste ink in the waste ink storing apparatus, the inkjet printer can maintain excellent image quality.

While the present invention has been particularly illustrated and described with reference to exemplary embodiments thereof, it will be understood by those of ordinary skill in the art that various changes in form and details may be made therein without departing from the spirit and scope of the present invention as defined by the following claims.

What is claimed is:

1. An inkjet printer comprising:
a print head including a nozzle unit as wide as a sheet of paper; and
a waste ink storing apparatus extending across the width of the print head and including a multi-absorption structure for absorbing and storing waste ink remaining when an image is formed.

2. The inkjet printer of claim 1, wherein the waste ink storing apparatus comprises:
an absorbing unit positioned above a container for absorbing the waste ink produced by the nozzle unit; and
a storing unit installed in a predetermined space of a space unit under the absorbing unit for storing the waste ink from the absorbing unit.

3. The inkjet printer of claim 2, wherein the space unit has the capacity to accommodate the volume of the storing unit increased when the storing unit absorbs the waste ink.

4. The inkjet printer of claim 2, wherein the storing unit comprises a polymer.

5. The inkjet printer of claim 4, wherein the storing unit stores the waste ink in a gel state.

6. The inkjet printer of claim 2, wherein the storing unit comprises calcium chloride.

7. The inkjet printer of claim 6, wherein the storing unit stores the waste ink in a liquid state.

8. The inkjet printer of claim 2, wherein the waste ink storing apparatus further comprises a filtering unit interposed between the absorbing unit and the storing unit for allowing the waste ink to flow from the absorbing unit to the storing unit but preventing the reverse flow.

9. A method of controlling waste ink in an inkjet printer, the method comprising the steps of:
providing a nozzle unit as wide as a sheet of paper;
absorbing waste ink remaining when an image is formed; and
storing said ink.

10. The method according to claim 9, wherein the storing step further comprises storing said ink in an absorbent polymer.

11. The method according to claim 9, wherein the storing step further comprises storing said ink in a gel state.

12. The method according to claim 9, wherein the storing step further comprises storing said ink in a storing unit comprising calcium chloride.

13. The method according to claim 9, wherein the storing step further comprises storing said ink in a liquid state.

14. The method according to claim 9, further comprising filtering said ink to allow said ink to flow from an absorbing unit to a storing unit but preventing a reverse flow.
